(19) United States
(12) Patent Application Publication
(10) Pub. No.: US 2024/0086546 A1
(43) Pub. Date: Mar. 14, 2024

(54) MEDIA PRIVACY WITHOUT COMPROMISING MONITORING EFFECTIVENESS

(71) Applicant: INTERNATIONAL BUSINESS MACHINES CORPORATION, ARMONK, NY (US)

(72) Inventors: Nixon Cheaz, Cary, NC (US); Chinh Vien Hoang, Markham (CA); VINCE SIU, Thornhill (CA); Steve Martinelli, Toronto (CA); Lisa Beth Lurie, New York, NY (US); William Troy Cochran, Apex, NC (US); James Ransom Talton, Cary, NC (US)

(21) Appl. No.: 17/931,292

(22) Filed: Sep. 12, 2022

(51) Int. Cl. G06F 21/57; G06F 21/55

(52) U.S. Cl. CPC G06F 21/577; G06F 21/552; G06F 2221/034

(57) ABSTRACT

Techniques are described with respect to a system, method, and computer product for privatizing media feeds. An associated method includes receiving a plurality of media data. The method further includes monitoring the plurality of media data, determining at least one vulnerable segment of the plurality of media data, and modifying the at least one vulnerable segment based on the determination.

### BACKGROUND

The present invention relates generally to media redaction, and more specifically, to generating augmented content for media redaction.

Monitoring and surveillance systems provide real-time observing of subjects in order to provide safety and security. However, with real-time observation comes the possibility of an invasion of privacy due to the lack of ability to detect and censor vulnerable components of live media.

Augmented reality technology enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes such as monitoring system footage. In particular, augmented reality may be utilized to optimize components captured within media feeds, such surveillance footage.

### SUMMARY

Additional aspects and/or advantages will be set forth in part in the description which follows and, in part, will be apparent from the description, or may be learned by practice of the invention.

A system, method, and computer product for privatizing media feeds is disclosed herein. In some embodiments, the computer-implemented method for privatizing media feeds includes receiving, by a computing device, a plurality of media data; monitoring, by the computing device, the plurality of media data; determining, by the computing device, at least one vulnerable segment of the plurality of media data; and modifying, by the computing device, the at least one vulnerable segment based on the determination.

In another aspect, a computer system for privatizing media feeds includes one or more processors, one or more computer-readable memories, and one or more computer-readable, tangible storage devices. Program instructions are stored on at least one of the one or more storage devices for execution by at least one of the one or more processors via at least one of the one or more memories, to perform operations comprising: receiving a plurality of media data; monitoring the plurality of media data; determining at least one vulnerable segment of the plurality of media data; and modifying the at least one vulnerable segment based on the determination.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary diagram depicting a sensor system according to at least one embodiment;

FIG. 2 illustrates a functional block diagram illustrating a media privatizing environment according to at least one embodiment;

FIG. 3 illustrates an exemplary data flow diagram associated with FIG. 2 depicting media privatizing according to at least one embodiment;

FIGS. 4A-C illustrate exemplary views of media data being privatized in the environment associated with FIG. 2 according to at least one embodiment;

FIG. 5 illustrates a flowchart depicting a process for privatizing media feeds, according to at least one embodiment;

FIG. 6 depicts a block diagram illustrating components of the software application of FIG. 1, in accordance with an embodiment of the invention;

FIG. 7 depicts a cloud-computing environment, in accordance with an embodiment of the present invention; and

FIG. 8 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for media privacy without compromising monitoring of subjects by privatizing media feeds. Monitoring and surveillance systems are configured to detect, monitor, and analyze footage of individuals in real-time. For example, home monitoring services are designed to provide older individuals along with their caregivers a sense of security by providing observation technologies configured to alert the proper parties upon the occurrence of an emergency. However as these systems continue to develop, there is a demand for limiting the invasion of privacy of the day to day life of the subjects being monitored. For example, a monitored subject may not desire the monitoring party to view certain actions/expressions that would objectively be considered an invasion of privacy (e.g. using the bathroom, viewing confidential information, etc.). Utilizing various video processing and machine learning technologies supports the detection-based elimination and redaction of media such as video feeds; however, elimination and various redactions of video may result in the monitoring parties being unable to ascertain important details such as whether an emergency is occurring. In addition, in conventional technologies, video processing and redaction is limited to audio and video data within the video stream leaving other types of data configured to be acquired in a media stream to be unaccounted for (e.g., LIDAR data, sonar data, infrared data, temperature data, geolocation data, time data, etc.). Thus, the present embodiments have the capacity to encrypt media and detect segments of the media that may be deemed vulnerable and modify the vulnerable segments of the media by altering various sounds, objects, geolocation data, LIDAR data, sonar data, time data, etc. within the vulnerable segments. The present embodiments further have the capacity to overlay media data with digital character models on vulnerable segments in which the digital character models are configured to emulate derivatives of the expressions (e.g., actions, sounds, objects, etc.) of the user and environment prior to presentation of the modified media to the applicable monitoring parties while maintaining confidentiality, as discussed.

As described herein, an avatar is a static or animated digital character model formed using a computer graphical image configured to represent one or more components within a media feed, virtual reality, augmented reality, and/or mixed reality environment along with protect the privacy and confidentiality of the monitored subject. In some embodiments, the avatar is configured to interact with viewers and may produce media content, notifications, and/or provide access to particular destinations (e.g., transfer VR/AR users to other applications).

As described herein, a vulnerable segment is a portion of an audio, video, etc. file including one or more data components objectively and/or subjectively considered to include vulnerable material not designed to be viewed by others. Examples include but are not limited to depiction of personal information (e.g., phone numbers, credit card numbers, etc.), a user using the bathroom, flatulence, nudity, geolocation data, time data, LIDAR data, sonar data, or any other applicable type of vulnerable material known to those of ordinary skill in the art.

An exemplary sensor system 100 is depicted according to an exemplary embodiment. Sensor system 100 is designed to include various types of sensors including but not limited to position sensors, pressure sensors, cameras, microphones, LIDAR sensors, sonar sensors, infrared sensors, temperature sensors, biological-based sensors (e.g., heartrate, movement, facial expressions, etc.), or any other applicable type of sensors known to those of ordinary skill in the art. In a preferred embodiment, sensor system 100 includes a plurality of cameras 102A-H configured to capture image, video, and audio data associated with a user 110 from multiple viewpoint to form a video stream 115 configured to be received by a server 120. Video stream 115 is a plurality of media data (including LIDAR data, sonar data, geolocation data, time data, etc.) relating to user 110 in which video stream 115 may be partitioned, segmented, etc. for the purpose of analyses based on allocation rendered by server 120. In some embodiments, server 120 is configured to perform 3D reconstruction by generating a 3D point cloud of the environment, user 110, and/or objects in the environment based on collected datapoints in the media data, according to embodiments of the present systems and methods. Server 120 is designed to detect user 110 and other relevant components of the captured footage, and generate an expression model based on datapoints derived from video stream 115. The expression model is configured to account for positions, movements, gestures, etc. of user 110 in addition to objects that user 110 interacts with within the recorded environment. For example, user 110 may be holding a credit card in his/her hands in which server 120 may detect and classify the credit card and associated actions performed by user 110 as vulnerable material and include indications of this within the plurality of media data (e.g., applying relevant metadata to the applicable frame). Sensor system 100 may further support integration of computer vision systems, image processing systems, audio processing systems, or any other applicable artificial intelligence based type of system known to those of ordinary skill in the art. It should be noted that one of the purposes of sensor system 100 is to collect real-time footage and applicable data pertaining to user 110 and objects user 110 interacts with in order to develop the model in which the model including the 3D point cloud may be used for tracking in various applications (e.g., augmented reality applications, etc.) via matching points from the cloud to regions in video stream 115.

As will be discussed in greater detail throughout the disclosure, sensor system 100 generates video stream 115 in a manner in which a raw/unencrypted version of video stream 115 is never transmitted to applicable monitoring systems in order to ensure that vulnerable segments are not viewed. In other words, raw/unencrypted version of video stream 115 is sent only to server 120 allowing server 120 to transmit video stream 115 to the applicable module for privatization prior to being received by monitoring systems. In some embodiments, server 120 is configured to generate a centralized platform designed to allow user 110 to view, edit, and provide preferences associated with sensor system 100 on interfaces provided to an applicable computing device. Computing devices may include, without limitation, smartphones, tablet computers, laptop computers, desktop computers, computer-mediated reality (CMR) devices/virtual reality devices, and/or other applicable hardware/software.

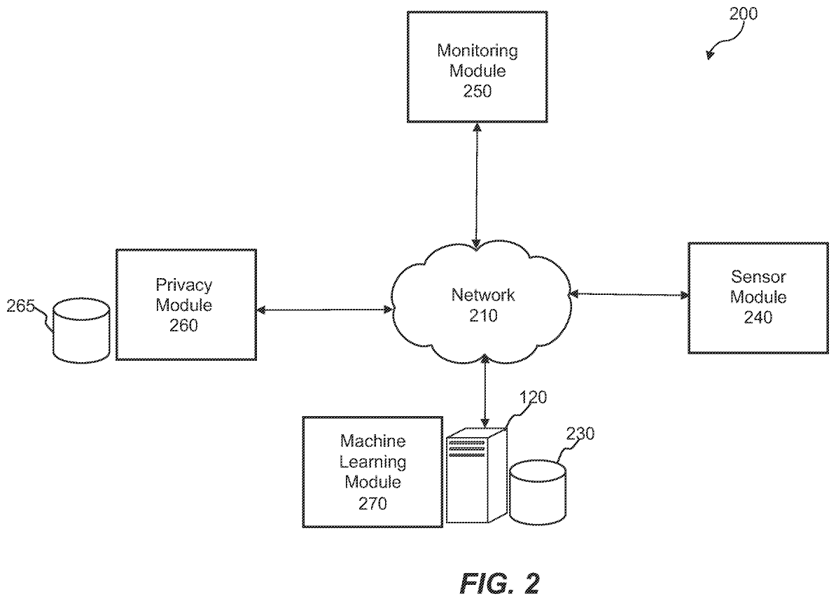

Referring now to FIG. 2, an environment 200 for media feed privatization is depicted according to an exemplary embodiment. FIG. 2 provides only an illustration of implementation and does not imply any limitations regarding the environments in which different embodiments may be implemented. Modifications to environment 200 may be made by those skilled in the art without departing from the scope of the invention as recited by the claims. In some embodiments, environment 200 includes server 120 and a communicatively coupled database 230, a sensor module 240 communicatively coupled to sensor system 100, a monitoring module 250, and a privacy module 260 communicatively coupled to a cloud database 265, each of which are communicatively coupled over a network 210. It should be noted that environment 200 is a network of computers in which the illustrative embodiments may be implemented, and network 210 is the medium used to provide communications links between various devices and computers connected together within environment 200. Network 210 may include connections, such as wire, wireless communication links, or fiber optic cables. Network 210 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. It should be appreciated that FIG. 2 provides only an illustration of one implementation and does not imply any limitations with regard to the environments in which different embodiments may be implemented. Many modifications to the depicted environments may be made based on design and implementation requirements. For example, sensor module 240, monitoring module 250, and privacy module 260 may be components of server 120.

In some embodiments, each of sensor module 240, monitoring module 250, privacy module 260 are communicatively coupled to a machine learning module 270 associated with server 120 configured to use one or more heuristics and/or machine learning models for performing one or more of the various aspects as described herein. In some embodiments, the machine learning models may use a wide variety of methods/techniques or combinations of methods/techniques, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriorist algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In some embodiments, the machine learning module 270 utilizes data sourced from one or more of sensor system 100, server 120, and/or any of the aforementioned modules as training data sources utilized by one or more machine learning models configured to generate predictions pertaining to sensor system 100, user 110, the environment, and objects within. For example, predictions pertaining to classifications of data and objects within footage as vulnerable material within the environment being captured by sensor system 100 may be generated and utilized to designate sections of video stream 115 as vulnerable segments.

Sensor module 240 performs management and maintenance of sensor system 100 and its components along with managing collection of video stream 115 prior to transmission to server 120. For example, sensor module 240 instructs sensor system 100 to collect video stream 115 in a manner in which video stream 115 includes a plurality of frames Frame 1, Frame 2, . . . , Frame N in sequence. The frames are tagged with metadata Metadata 1, Metadata 2, . . . , Metadata N which describe the content and/or characteristics associated with the frames. The metadata for each frame may include information to indicate type of data within the frame (e.g., audio data, LIDAR data, sonar data, geolocation data, etc.), a timestamp for the frame, process the frame, keywords/tags indicating the persons, objects, or other content depicted in the frame. In some embodiments, the metadata indicates whether or not the frame includes vulnerable material and thus should be included in a vulnerable segment. In addition to the metadata, each frame may be tagged with reference REF₁, REF₂, . . . , REF_{N} to a previous frame to prevent tampering and gaps in the video stream 115 and in the sequential reference through video stream 115. Privacy module 260 communicates with sensor module 240 in order for privacy module 260 to encrypt each of the plurality of frames. An important function of privacy module 260 is the ability to utilize sensor data derived from sensor system 100 in order to not only privatize audio, video, sonar, LIDAR, time, geolocation, etc. data within video stream 115, in order to preserve privacy and confidentiality. For example, privacy module 260 maintains usefulness video stream 115 by encrypting components of the aforementioned data. This allows for full viewing of the unredacted video if needed, and only to those who are authorized to do so.

In some embodiments, video stream 115 is transmitted to server 120 in two distinct versions, an unredacted/raw unencrypted version which has not been processed by privacy module 260 and a redacted/encrypted version in which the plurality of frames have been encrypted by privacy module 260. Video stream 115 continuously being transmitted to privacy module 260 would require the privacy module 260 to use an exorbitant amount of computing resources to process such a massive amount of data; thus, server 120 may designate which frames of the plurality of frames are to be classified based on analyzing the frames for vulnerable segments.

Ascertaining the vulnerable segments is performed by server 120 utilizing the machine learning module 270 to perform analyzing, marking, and classification of the plurality of frames based upon their content. In addition, machine learning module 270 may utilize machine learning modules to predict vulnerable segments of video stream 115 and/or predict classification of frames as including vulnerable material. For example, machine learning module 270 may indicate that the frame 40 through frame 62 require marking because they include footage of user 110 reading their credit card number aloud in which server 120 marks each of frames 40-62 as vulnerable material prior to being sent to privacy module 260. Upon receiving the plurality of frames, privacy module 260 not only encrypts the plurality of frames but also modifies frames 40-62 by performing redaction of frames 40-62 based on the markings. The resulting video stream 115 including the vulnerable segments is transmitted to monitoring module 250 for the purpose of viewing video stream 115 in the redacted state. Monitoring module 250 may include any applicable type of monitoring or surveillance service including but not limited to a security monitoring service, elderly monitoring service, baby monitoring services, or any other applicable monitoring or surveillance footage service known to those of ordinary skill in the art. Although monitoring module 250 may be an external party receiving a redacted/encrypted version of video stream 115, in some embodiments, monitoring module 250 may include a server-side detection module configured to continuously monitor video stream 115 and alert server 120 to detect user 110 along with vulnerable segments of video stream 115. The detection may be based upon comparing the actions of user 110 to a pre-defined blacklist of topics and/or activities deemed vulnerable material; however, the vulnerable material may be determined based on the comparison. The machine learning module 270 may contribute topics/activities to the pre-defined list based on analysis of video streams which ascertains patterns of user 110 and/or user 110 may provide topics/activities via the centralized platform. In addition, the blacklist may be incremented continuously by the machine learning model comparing the expression model to expressions performed by user 110 within the footage in future iterations and adding newly discovered expressions. In a preferred embodiment, server 120 analyzes video stream 115 for static or behavior included within the blacklist in order for privacy module 260 to generate the encrypted version of video stream 115 including the applicable redactions. In some embodiments, privacy module 260 merges the encrypted and unencrypted versions of video stream 115 into a single stream including permission metadata indicating which viewing parties have access to which elements of video stream 115 (e.g., permissions allocated depending on monitoring party).

Cloud database 265 is configured to store datapoints collected by sensor system 100, and database 230 is designed to store a blockchain/distributed ledger that references video stream 115. The blockchain includes a plurality of cryptographically linked blocks in an ordered sequence, each of the plurality of blocks including a header, a version of the video stream 115 with metadata, a tracking value, and any other applicable blockchain components known to those of ordinary skill in the art. The version of the video stream 115 in each of the plurality of blocks corresponds to an original version of video stream 115 or a processed version of video stream 115. Server 120 generates the tracking values based on attributes of the version of video stream 115 referenced. Datapoints may include facial expression data of user 110, movement data of user 110, and/or 3D data points in which each point for each frame in the plurality of frames of video stream 115 corresponds to user 110, an object within the environment recorded by sensor system 100, or the environment itself. In some embodiments, server 120 may utilize to the datapoints to generate an augmented reality, virtual reality, and/or mixed reality environment based on the environment ascertained from sensor system 100. It should be noted that one of the uses of generating an environment based on the datapoints is to allow server 120 to generate one or more avatars configured to be overlayed on user 110, objects within the environment, etc. For example, a 3D model of user 110 and/or objects that are to be displayed in the environment in video stream 115 may be generated and displayed on the encrypted frames.

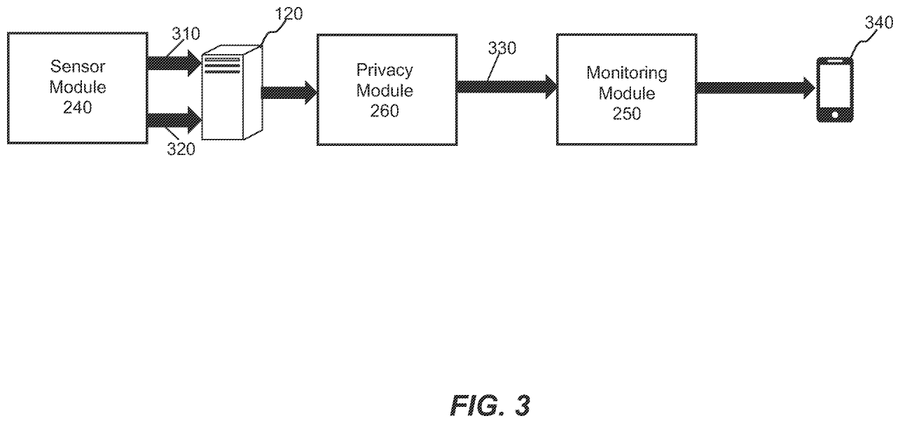

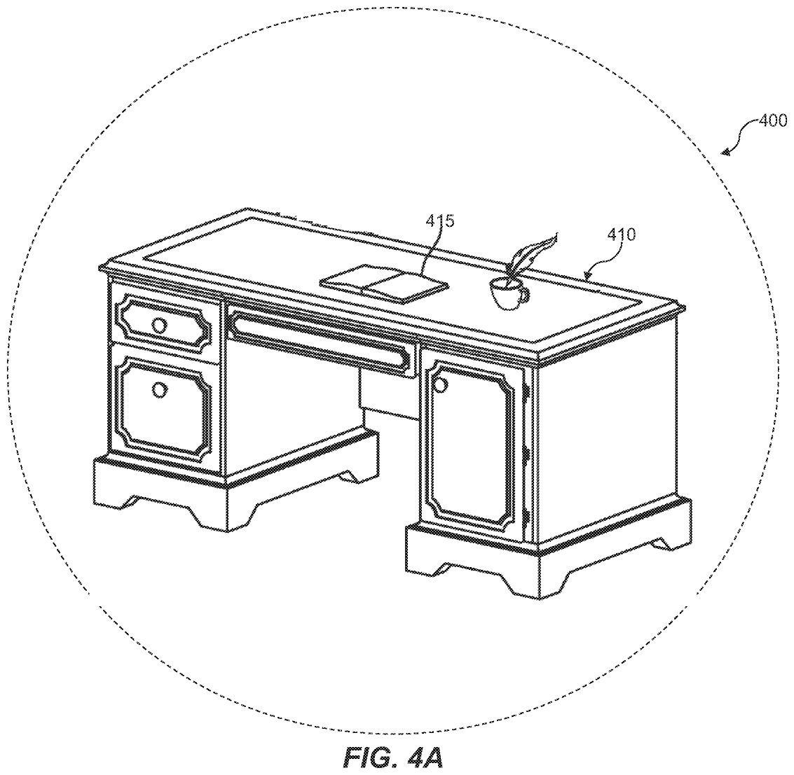

Referring now to FIG. 3, a data flow 300 associated with environment 200 is depicted, according to an exemplary embodiment. Sensor module 240 collects video stream 115 including applicable video, audio, and image data from sensor system 100. Sensor module 240 may further collect from sensor system 100 various data such as movement data, biological data, etc. derived from one or more wearable devices donned by user 110 allowing server 120 to utilize the machine learning module 270 to generate the expression model associated with user 110 based on the collected data. In addition to the 3D model and expression model being transmitted to privacy module 260, unmedia data 310 derived from video stream 115 and media data 320 derived from video stream 115 are transmitted privacy module 260; however, privacy module 260 is designed to encrypt media data of video stream 115 if necessary. For each frame, privacy module 260 analyzes the content of the frame and metadata in order to not only ascertain actions occurring within the environment, but also to determine if the frame is part of a vulnerable segment. A method of analyzing the content of the frame is to compare the content of each frame to data derived from the 3D model and expression model. Based on privacy module 260 determining that one or more frames of the plurality of frames include vulnerable material, privacy module 260 establishes the one or more frames are a vulnerable segment of video stream 115.

In some embodiments, privacy module 260 includes an avatar management module (not pictured) configured to generate the one or more avatars designed to be overlayed on media data 320. The centralized platform is configured to provide user 110 with interfaces of the avatar management module in order to allow customization and editing the avatar. Overlaying the avatar on media data 320 results in a modified video stream 330 being transmitted to monitoring module 250 for viewing by the applicable monitoring party on a monitoring computing device 340. In a preferred embodiment, modified video stream 330 is video stream 115 however instead of user 110 being visible during the applicable timeframes associated with the vulnerable segments, the avatar is overlaid in the position of user 110. The avatar is further configured to emulate the expressions, actions, etc. of user 110 by privacy module 260 utilizing the data derived from the 3D model and the expression model.

As described herein, modification may refer to any alterations rendered on video stream 115 including but not limited to redaction (e.g., video, image, audio, LIDAR data, sonar data, etc.), censoring (e.g., blurry overlay, blackout, etc.), elimination of elements within the environment, etc. For example, video stream 115 may depict user 110 performing a certain gesture and emitting flatulence which has a sound, in which the classification of the relevant frames as a vulnerable segment results in privacy module 260 overlaying the avatar in the applicable frames not only emulating/re-enacting/recreating/mimicking the certain gesture, but also emitting modified audio (e.g., cartoon noises, honking, etc.) rather than the sound of the flatulence along with other media data (e.g., LIDAR data, sonar data, time data, geolocation data, etc.) if applicable. In some embodiments, elements associated with the gesture classified as vulnerable may also be redacted via overlaying mechanisms. For example, snot emitted during a sneeze (e.g., which is redacted) along with its associated sound may be overlayed with visual graphics embedded and modified audio on the vulnerable segment to prevent the monitoring party from viewing or viewing in a modified manner.

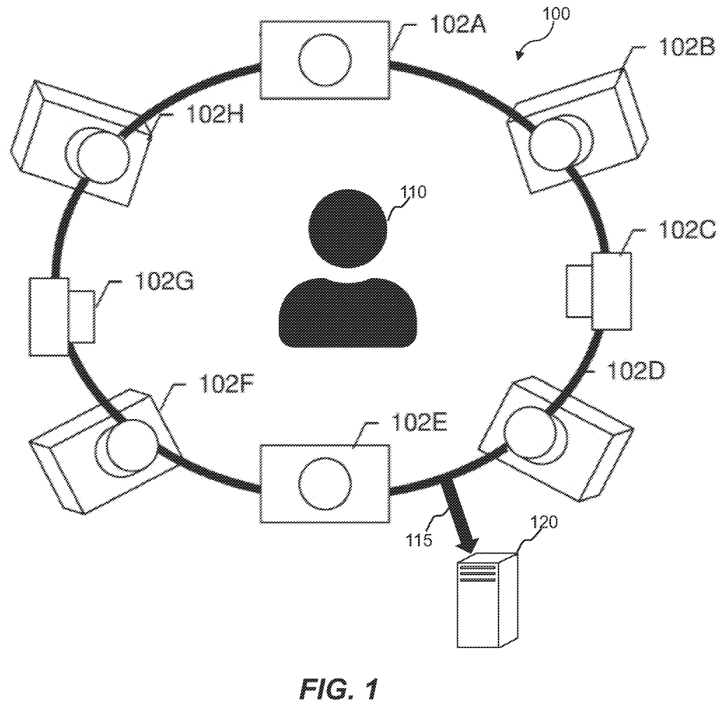

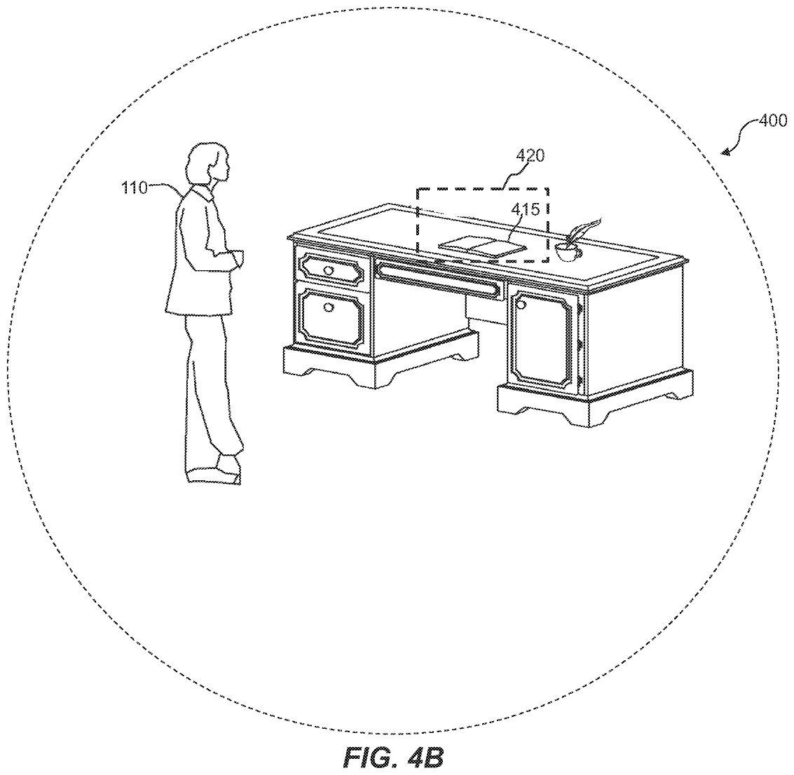

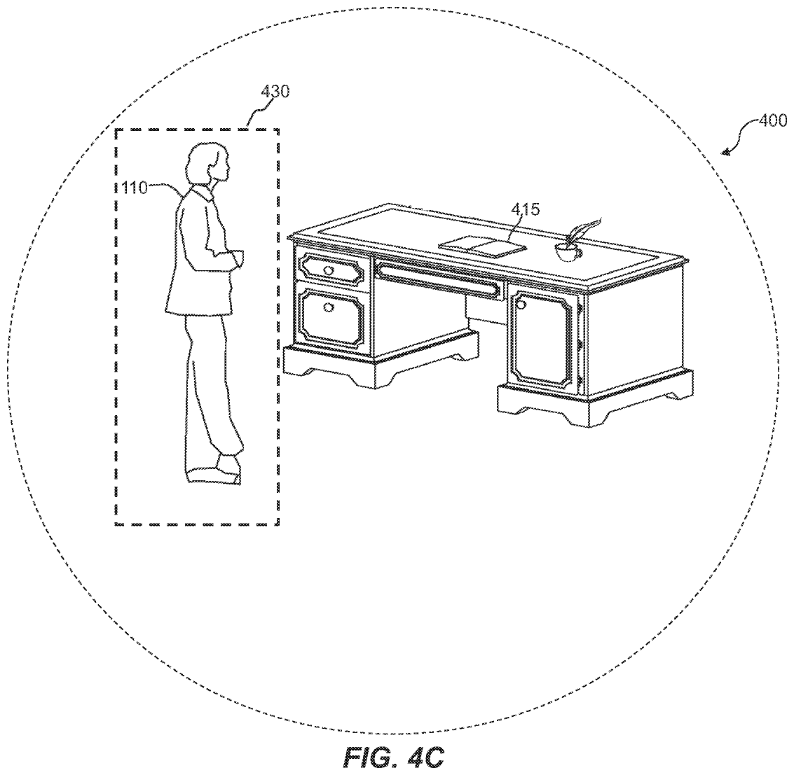

Referring now to FIGS. 4A-C, an exemplary view 400 is depicted of a media stream according to an exemplary embodiment. View 400 may be a traditional media stream depiction, a virtual reality view, an augmented reality view, a mixed reality review, and/or any other applicable type of depiction configured to be received by a monitoring party, e.g., to be viewed on the monitoring computing device 340 shown in FIG. 3. Because view 400 takes place in the greater context of the real world (shown in FIG. 1), references may be made to the features of FIG. 1. View 400 includes a desk 410 including an object 415. The purpose of FIG. 4A is to show that when user 110 is not being monitored by sensor system 100 server 120 may still generate a 3D point cloud of the environment with the goal of privatizing any objects or content of objects within environment 100 that are deemed vulnerable material. Sensor system 100 can only support a finite number of pre-defined object types, such as individual persons, faces, group of people, objects, etc. Thus, server 120 supports object identification and tracking to allow privacy module 260 to analyze objects within the video stream and determine if the objects warrant privatization. For example, in the instance in which privacy module 260 detects that an object in view 400 is a credit card, privacy module 260 automatically determines that privatization is warranted in order to protect the confidential information (e.g., credit card number) of user 110. Once server 120 receives video stream 115 from sensor system 100, server 120 may assign an interest/priority value to each object detected within video stream 115 in which the interest/priority values are values that rank the level of sensitivity associated with the object. Factors may be considered in the calculation of interest/priority values such as level of importance of the object to user 110, location of the object relative to other objects that are pre-defined vulnerable object types (e.g., a toilet, shower, etc.), appearance of corporate logos, etc. The interest/priority value is included within the plurality of metadata and is tagged to each frame that the applicable object is depicted within. For example since object 415 is resting on desk 415, if desk 415 is an area that user 110 normally frequents and performs other potentially vulnerable actions (e.g., entering passcodes on a laptop placed on desk 415, conducting calls/meetings regarding proprietary information, etc.), then privacy module 260 allocates an overlay 420 to object 415. Overlay 420 may be an opaque film, an avatar, a blackout film, or any other applicable type of visual redaction. In some embodiments, overlay 420 is an emoji or emoticon which is an icon, picture, pictogram, etc. expressing an idea or emotion of user 110.

In this example, object 415 is a recordkeeping book that includes vulnerable material such as confidential records and notes in which privacy module 206 analyzes the metadata including the interest/priority values and allocates overlay 420 while simultaneously not privatizing user 110 as depicted in FIG. 4B. It should be noted that solely privatizing object 415 is a result of privacy module 206 not detecting user 110 performing an action/expression that is deemed as vulnerable material based on the metadata. However, FIG. 4C depicts privacy module 260 not only detecting user 110 within the environment, but also user 110 performing an action/expression that is deemed as vulnerable material (e.g. emitting flatulence). As a result, privacy module 260 allocates an overlay avatar 430 configured to mask both the action and associated data within the video stream (e.g., sound, LIDAR data, sonar data, geolocation data, etc.) within each frame including the vulnerable material. This allows the vulnerable segment (e.g., the collection of frames including the vulnerable material) to be depicted to the applicable monitoring party as an encrypted video stream including overlay avatar 430 embedded over user 110 and the original audio of the action/expression being modified in manner where it is not apparent to a third party what action/expression is occurring. In the illustrated embodiment, overlay avatar 430 has the form of a silhouette of human, although there are many other forms that overlay avatar 430 could take. For example, the avatar forms can be a human, non-human, animal, machine, or fantasy creature; stationary or mobile. In some embodiments, overlay avatar 430 may replicate the action/expression of user 110 in a modified version based on the expression model derived from the machine learning module 270 iterations relating to movements and gestures of user 110. In other words, sensor derived data from sensor system 100 is utilized by the machine learning models in order to identify patterns of user 110. For example upon detecting user 110 picking her nose, privacy module 260 determines the applicable frames include vulnerable material and classifies the frames as a vulnerable segment of media stream 115. As a result, privacy module 260 allocates overlay avatar 430 to the vulnerable segment in which overlay avatar 430 is positioned directly on user 110 and configured to emulate the nose picking motion of user 110 in modified manner that preserve privacy. In some embodiments, overlay avatar 430 may perform a different action from the current action of user 110 that privacy module 260 is privatizing. It should be noted that the purpose of privacy module 260 privatizing the vulnerable segments is to prevent the applicable monitoring party from viewing the video stream in its original state (along with its applicable data and metadata) and invading the privacy of user 110 inherent with the exposure of the vulnerable material.

In some embodiments, the process of redacting vulnerable segments of media stream 115 is accomplished by privacy module 260 utilizing an automated process to classify the vulnerable segment. For example, upon server 120 establishing that Frame 115 to Frame 180 include vulnerable material, server 120 and/or privacy module 260 applies markings indicating vulnerable material to at least one of the aforementioned frames in order for privacy module 260 to automatically ascertain that Frame 115 through Frame 180 is a vulnerable segment.

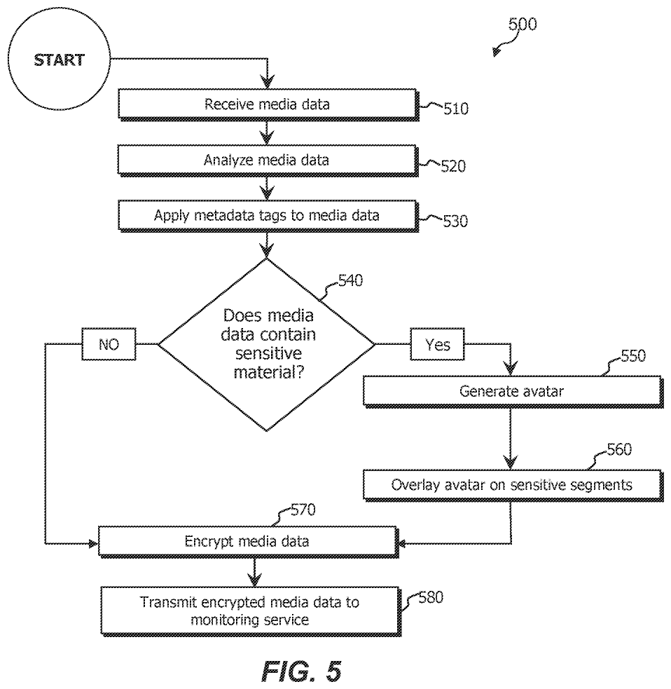

With the foregoing overview of the example architecture, it may be helpful now to consider a high-level discussion of an example process. FIG. 5 depicts a flowchart illustrating a computer-implemented process 500 for privatizing media feeds, consistent with an illustrative embodiment. Process 500 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 510 of process 500, a plurality of media data is received by sensor system 100. In a preferred embodiment, the plurality of media data is received via a video stream in a manner in which datapoints of the video stream correspond to one or more of user 110, objects within the environment being recorded, or the environment overall. Sensor system 100 is further configured to generate a 3D model reflecting the recorded environment based on the plurality of media data including video data, audio data, LIDAR data, sonar data, geolocation data, time data, and any other applicable type of data derived from footage. Not only is the 3D model utilized to detect and track objects depicted in the video stream, but also to help render a virtual reality, augmented reality, and/or mixed reality-based depiction of the video stream.

At step 520 of process 500, the plurality of media data including the datapoints are analyzed by server 120. One purpose of analyzing the media data is to allow server 120 to generate metadata configured to be tagged to the plurality of frames of the video stream. As previously mentioned, the metadata may account for the location of user 110 and objects within the environment being recorded, timestamps, keywords/tags, interest/priority values, and indicative markers of the presence of vulnerable material within frames. Designations of the interest/priority values are the results of iterations of machine learning module 270 in which machine learned models are trained based on the plurality of media data in addition to activity patterns, preferences, and any other applicable data associated with user 110. For example, user 110 may indicate on the centralized platform that a particular object is private and confidential in which frames including said object are tagged as vulnerable material warranting censorship/privatization.

At step 530 of process 500, the metadata is tagged to the applicable frames of the video stream. Tagging the metadata to the frames assists machine learning module 270 with classifying the frames that include vulnerable material along with classifying the datapoints. In addition, tagging the metadata allows privacy module 206 to ascertain which components of the video stream need to be encrypted prior to the generation of the modified video stream including one or more redacted elements being sent to the applicable monitoring party.

At step 540 of process 500, privacy module 260 makes the determination as to whether the video stream includes vulnerable material. The determination is based on the metadata and the markers indicating that the video stream includes a vulnerable segment. The vulnerable segment is the portion of the video stream that privacy module 260 will augment the overlay avatar into in addition to modify applicable data elements within the recorded environment including video data, audio data, LIDAR data, sonar data, geolocation data, etc.

If privacy module 260 determines that the video stream does include vulnerable material, then step 550 of process 500 occurs in which privacy module 260 generates the avatar based on the metadata indicating the elements of the vulnerable material. At step 560 of process 500, privacy module 260 modifies the vulnerable segment by overlaying the avatar in each frame of the plurality of frames that make up the vulnerable segment along with modifies the applicable data of the footage that warrants confidentiality within the vulnerable segment. In some embodiments, privacy module 260 utilizes the datapoints in order to detect background objects/elements within the environment and overlays and/or redacts said objects/elements if classified as vulnerable material. Otherwise, if privacy module 260 determines that the video stream does not include one or more vulnerable segments then privacy module 260 proceeds directly to step 570.

At step 570 of process 500, privacy module 260 encrypts either the original video stream that does not include vulnerable segments or the modified video stream that includes redactions at the vulnerable segments, or privacy module 260 merges unmedia data and media data in a video stream including permission metadata indicating the receiving parties of the footage and which segments and elements of the video stream are accessible (e.g., redacted or unredacted subject to the viewing party) wherein the elements include video data, audio data, LIDAR data, sonar data, etc. In some embodiments, selection and encryption of the video stream or variations thereof are transmitted based on the permission data allocated by server 120 taking into consideration who the receiving party is (e.g., the monitoring party, etc.). For example, a variation of the modified video stream including media data may be selected for transmission based upon server 120 determining that the monitoring party is a particular type of monitoring service (e.g., elderly care accident prevention service). Permission metadata serves as an indicator of which components of the video stream are to be viewed in an original or modified manner (footage including modified vulnerable segments) to each respective monitoring service receiving the video stream. For example, a first monitoring service may receive the video stream including unencrypted media data and a second monitoring service may receive a variation of the video stream with various frames encrypted and redacted based upon the permission metadata. In addition, the avatar is overlayed in a manner in which the monitoring party would still be able to ascertain if an emergency associated with user 110 is occurring (e.g., emitting flatulence while having a heart attack). In some embodiments, privacy module 260 is continuously monitoring the video streams in order to ensure that actions of the user performed during vulnerable segments are not going undetected. The purpose of encrypting the video streams transmitted to the applicable monitoring parties is to ensure that manipulation of the video streams is not possible along with ensuring that tracking of the video stream is maintained on the blockchain. As previously mentioned, each of the plurality of blocks of the blockchain correspond to an original version of the video stream or a modified version of video stream rendered by privacy module 260. At step 580 of process 500, either the encrypted version of the original video stream or the encrypted version of the modified/redacted video stream is transmitted to a computing device of the applicable monitoring party for viewing subject to the permission metadata.

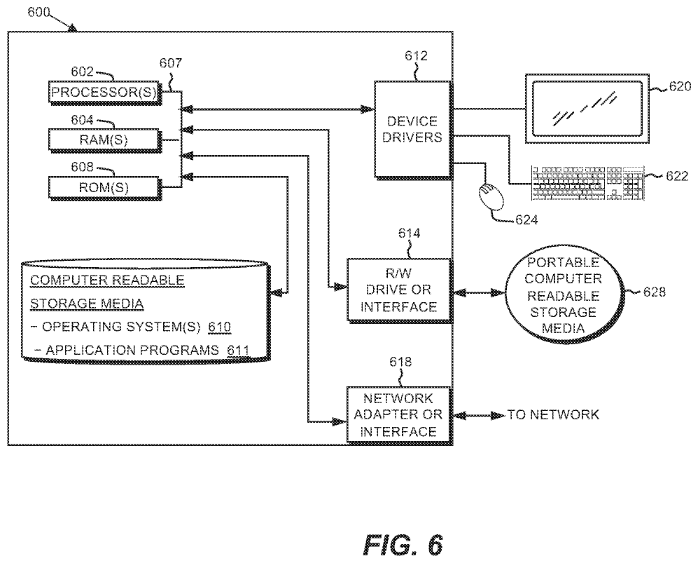

FIG. 6 is a block diagram of components 600 of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Components 600 is representative of any electronic device capable of executing machine-readable program instructions. Components 600 may be representative of a smart phone, a computer system, PDA, or other electronic devices. Examples of computing systems, environments, and/or configurations that may represented by components 600 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. The one or more servers may include respective sets of components illustrated in FIG. 6. Each of the sets of components include one or more processors 602, one or more computer-readable RAMs 604 and one or more computer-readable ROMs 606 on one or more buses 607, and one or more operating systems 610 and one or more computer-readable tangible storage devices 608. The one or more operating systems 610 may be stored on one or more computer-readable tangible storage devices 608 for execution by one or more processors 602 via one or more RAMs 604 (which typically include cache memory). In the embodiment illustrated in FIG. 6, each of the computer-readable tangible storage devices 608 is a magnetic disk storage device of an internal hard drive. Alternatively, each of the computer-readable tangible storage devices 608 is a semiconductor storage device such as ROM 606, EPROM, flash memory or any other computer-readable tangible storage device that can store a computer program and digital information.

Each set of components 600 also includes a R/W drive or interface 614 to read from and write to one or more portable computer-readable tangible storage devices 608 such as a CD-ROM, DVD, memory stick, magnetic tape, magnetic disk, optical disk or semiconductor storage device. A software program can be stored on one or more of the respective portable computer-readable tangible storage devices 608, read via the respective RAY drive or interface 614 and loaded into the respective hard drive.

Each set of components 600 may also include network adapters (or switch port cards) or interfaces 618 such as a TCP/IP adapter cards, wireless wi-fi interface cards, or 3G or 4G wireless interface cards or other wired or wireless communication links. Applicable software can be downloaded from an external computer (e.g., server) via a network (for example, the Internet, a local area network or other, wide area network) and respective network adapters or interfaces 616. From the network adapters (or switch port adaptors) or interfaces 618, the centralized platform is loaded into the respective hard drive. The network may comprise copper wires, optical fibers, wireless transmission, routers, firewalls, switches, gateway computers and/or edge servers.

Each of components 600 can include a computer display monitor 620, a keyboard 622, and a computer mouse 624. Components 600 can also include touch screens, virtual keyboards, touch pads, pointing devices, and other human interface devices. Each of the sets of components 600 also includes device processors 602 to interface to computer display monitor 620, keyboard 622 and computer mouse 624. The device drivers 612, R/W drive or interface 614 and network adapter or interface 618 comprise hardware and software (stored in storage device 608 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (Aasax): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

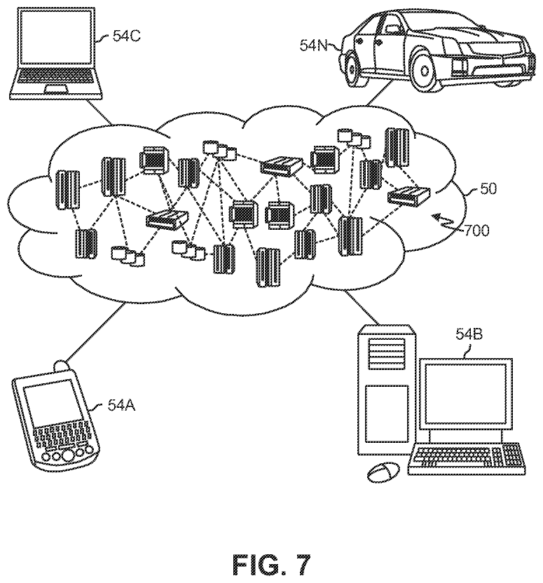

Referring now to FIG. 7, illustrative cloud computing environment 700 is depicted. As shown, cloud computing environment 700 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 54A-N shown in FIG. 7 are intended to be illustrative only and that computing nodes 50 and cloud computing environment 700 can communicate with any type of computerized device over any type of network and/or network addressable connection (e.g., using a web browser).

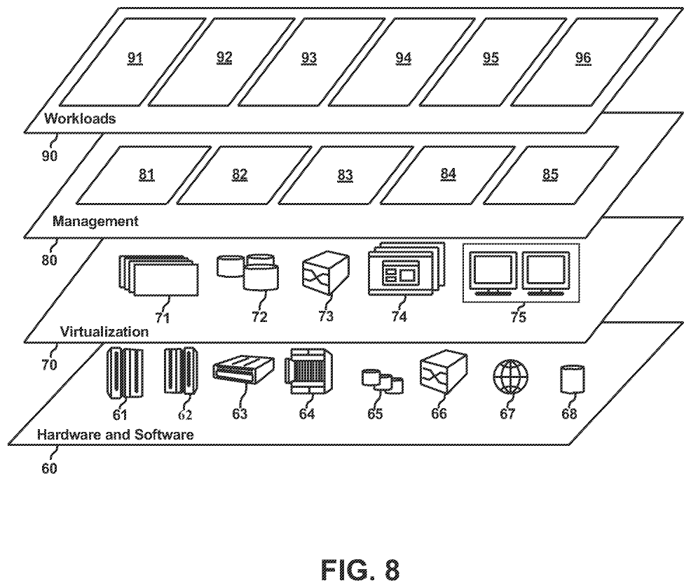

Referring now to FIG. 8 a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for privatizing media feeds comprising:
receiving, by a computing device, a plurality of media data;
monitoring, by the computing device, the plurality of media data;
determining, by the computing device, at least one vulnerable segment of the plurality of media data; and
modifying, by the computing device, the at least one vulnerable segment based on the determination.

2. The computer-implemented method of claim 1, wherein determining the at least one vulnerable segment comprises:
detecting, by the computing device, a user associated with the plurality of media data associated with at least one vulnerable material in the plurality of media data not designed to be viewed by others.

3. The computer-implemented method of claim 2, wherein the at least one vulnerable material is determined by comparing, by the computing device, a plurality of user expressions to a pre-defined expressions blacklist.

4. The computer-implemented method of claim 1, wherein modifying the at least one vulnerable segment comprises:
altering, by the computing device, a video stream element of the at least one vulnerable segment preventing it from being emitted in an original state.

5. The computer-implemented method of claim 2, wherein modifying the at least one vulnerable segment comprises:
generating, by the computing device, an avatar configured to emulate the at least one vulnerable material; and
overlaying, by the computing device, the avatar over the at least one vulnerable segment.

6. The computer-implemented method of claim 5, wherein the avatar is configured to be embedded in at least one of a virtual reality environment, an augmented reality environment, or a mixed reality environment.

7. The computer-implemented method of claim 1, further comprising:
determining, by the computing device, a receiving party for the plurality of media data including the modified vulnerable segment; and
selecting, by the computing device, a variation of the plurality of media data based on the determination.

8. The computer-implemented method of claim 1, wherein the plurality of media data comprises one or more of video data, audio data, LIDAR data, sonar data, temperature data, and infrared data.

9. The computer-implemented method of claim 1, wherein modifying the at least one vulnerable segment comprises:
merging, by the computing device, the plurality of media data and the plurality of media data in a video stream comprising permission metadata;
wherein the video stream is transmitted based on the permission metadata.

10. The computer-implemented method of claim 1, wherein the plurality of media data are maintained on a blockchain comprising a plurality of cryptographically linked blocks.

11. A computer system for privatizing media feeds, the computer system comprising:
one or more processors, one or more computer-readable memories, and program instructions stored on at least one of the one or more computer-readable memories for execution by at least one of the one or more processors to cause the computer system to:
program instructions to receive a plurality of media data;
program instructions to monitor the plurality of media data;
program instructions to determine at least one vulnerable segment of the plurality of media data; and
program instructions to modify the at least one vulnerable segment based on the determination.

12. The computer system of claim 11, wherein the program instructions to determine the at least one vulnerable segment comprise:
program instructions to detect a user associated with the plurality of media data performing at least one vulnerable material.

13. The computer system of claim 11, wherein the at least one vulnerable material is determined by program instructions to compare a plurality of user expressions to a pre-defined expressions blacklist.

14. The computer system of claim 11, wherein the program instructions to modify the at least one vulnerable segment comprise:
program instructions to alter a video stream element of the at least one vulnerable segment preventing it from being emitted in an original state.

15. The computer system of claim 11, wherein the program instructions to modify the at least one vulnerable segment comprise:
program instructions to generate an avatar configured to emulate the at least one vulnerable material; and
program instructions to overlay the avatar over the at least one vulnerable segment.

16. The computer system of claim 15, wherein the avatar is configured to be embedded in at least one of a virtual reality environment, an augmented reality environment, or a mixed reality environment.

17. The computer system of claim 11, further comprising:
program instructions to determine a receiving party for the plurality of media data including the modified vulnerable segment; and
program instructions to select a variation of the plurality of media data based on the determination.

18. The computer system of claim 11, wherein the plurality of media data comprises one or more of video data, audio data, LIDAR data, sonar data, and infrared data.

19. The computer system of claim 11, wherein program instructions to modify the at least one vulnerable segment further comprise:
program instructions to merge the plurality of media data and the plurality of media data in a video stream comprising permission metadata;
wherein the video stream is transmitted based on the permission metadata.

20. The computer system of claim 11, wherein the plurality of media data are maintained on a blockchain comprising a plurality of cryptographically linked blocks.
